(19) United States
(12) Patent Application Publication
(10) Pub. No.: US 2010/0122082 A1
(43) Pub. Date: May 13, 2010

(54) USER IDENTITY VALIDATION SYSTEM AND METHOD

(76) Inventors: Leiwen Deng, Shanghai (CN); Aleksandar Kuzmanovic, Belgrade (RS)

Correspondence Address: MCANDREWS HELD & MALLOY, LTD, 500 WEST MADISON STREET, SUITE 3400, CHICAGO, IL, 60661, US

(21) Appl. No.: 12/569,401

(22) Filed: Sep. 29, 2009

Related U.S. Application Data
(60) Provisional application No. 61/103,672, filed on Oct. 8, 2008.

(51) Int. Cl. H04L 29/06

(52) U.S. Cl. 713/159

(57) ABSTRACT

An identity validation system and method for the Internet provides user accountability while supporting user privacy to counter SPAM, Internet vandalizers, and predators, as well as cyber bullies who use the Internet to communicate with actual or potential victims. The system includes network authority software that issues a permanent identity and secret code to a user and disseminates different hashed versions of the permanent identity and secret code to different agents. A user hardware Internet passport generates hashed versions of the permanent identity and secret code as well as a passcode that is generated from the hashed secret code and user software generates a temporary identity from the hashed permanent identity. The user software transmits the temporary identity and passcode to a selected agent that performs the actual identity validation.

### STATEMENT REGARDING FEDERALLY SPONSORED RESEARCH OR DEVELOPMENT

This work was supported by the National Science Foundation (NSF) Grant CNS-0831654.

### FIELD OF THE INVENTION

The present invention relates to an identity validation system and method for the Internet and more particularly to such a system and method that provides user accountability while supporting user privacy to counter SPAM, Internet vandalizers and predators or cyber bullies who use the Internet to communicate with actual or potential victims.

### CROSS-REFERENCE TO RELATED APPLICATIONS

N/A

### BACKGROUND OF THE INVENTION

The architecture of the Internet hides a user's real identify. This has caused tremendous problems because, heretofore, there has been no effective means to enable accountability. More particularly, on the Internet, an Email address is a typical example of a user's identity. Using a known security solution such as OpenPGP, one can verify the association between a user's Email address and the messages sent from that address. However, there is no effective way to counter SPAM because the Email address is meaningless unless the user of that address is known in advance. As such, when associated with an unknown Email address, one cannot tell whether an Email is sent from a spammer or not. Another example of user identity on the Internet is a web account. Only a small fraction of web accounts require a user's real name and verifiable information, e.g. credit card information, bank account information, etc., for registration. The remaining web accounts which are the vast majority, carry little meaningful information about a user's identity. As a result, they are subject to vandalizers and spammers. Moreover, it has become impossible to determine whether bloggers on a website are independent or interested and/or biased parties.

Further, one of the most serious problems caused by the anonymity of users on the Internet is that it has allowed predators to make contact with potential victims, including minors. In addition, the anonymity of users on the Internet has allowed cyber bullies, who send messages intended to hurt a recipient, to proliferate.

In view of the above, there is a need for user accountability while also supporting user privacy. While identity authentication systems, such as OpenID, are known, these systems suffer from lack of privacy. Specifically, with the OpenID system, a user registers an account with an identity provider, P, which issues the user an open identity, IDₚ, with which the user can use to log into a number of the provider P′s relying parties. However, because the user logs into all of the different relying parties using the same identity, the user can be easily tracked by others. Moreover, the actual identity authentication is always performed by the provider P in the OpenID system.

### SUMMARY OF THE INVENTION

In accordance with the present invention, the disadvantages of prior user identity validation or authentication systems for the Internet as discussed above have been overcome. The identity validation system and method for the Internet of the present invention provides user accountability while supporting user privacy to counter SPAM, Internet vandalizers, and predators as well as cyber bullies who use the Internet to communicate with actual potential victims.

More particularly, in accordance with one embodiment of the identity validation system of the present invention, a user registers the user's real identity with a home identity authority that has issued a unique permanent identity and secret code to the user. Home authority software that is executable by a processor generates a number of different hashed versions of the user's permanent identity and secret code using a number of different hash functions wherein each hash function is associated with a different agent. The home authority software then transmits the different hashed versions of the user's permanent identity and secret code to the respective agents.

The identity validation system of the present invention also includes a tamper resistant user passport device that has includes a memory for storing the user's permanent identity and secret code. The user passport device also includes a processor that is operable to generate hashed versions of the stored permanent identity and secret code using agent hash functions that are associated with the agent selected to perform the identity validation. The processor of the user passport device is also operable to generate a time varying passcode using the hashed version of the secret code.

The system and method of the present invention also includes user software that is executable on a personal data device, e.g. a personal computer, PDA, etc. The user software is operable to generate a temporary identity for the user that includes an encrypted version of the user's hashed version of the permanent identity and a public key for transmission with the passcode to the agent selected to perform the identity validation.

The system and method of the present invention further includes agent software that is executable by a processor to receive from the home authority a hashed version of a user's permanent identity and secret code wherein the agent stores this information. The agent software also receives a temporary identity and a passcode from the user that has selected the agent to perform the identity validation. The agent software validates the user's identity based upon the temporary identity and passcode received from the user and the stored hashed versions of the user's permanent identity and/or secret code.

The system and method of the present invention provides a representation of the user's identity to ensure user accountability for the user's actions on the Internet. The system and method of the present invention supports privacy by restricting the exposure of a user's real identity to only one third party, i.e. the user's home identity authority. Moreover, the present invention supports high scalability of the identity validation service.

These and other objects, advantages and novel features of the present invention, as well as details of an illustrative embodiment thereof, will be more fully understood from the following description and from the drawings.

### BRIEF DESCRIPTION OF THE DRAWINGS

FIG. 1 is an illustration of an identity validation system network in accordance with the present invention;

FIG. 2 is a block diagram illustrating an Internet passport in accordance with the present invention;

FIG. 3A is an illustration of merging of multiple identity verification systems as depicted in FIG. 1;

FIG. 3B is an illustration of a trust model of the identity validation system of FIG. 1;

FIG. 4A is an illustration of an online validation system in accordance with the present invention;

FIG. 4B is an illustration of an offline validation system in accordance with the present invention;

FIG. 5A is an illustration of the user side software in accordance with the present invention;

FIG. 5B is an illustration of the agent side software of the present invention;

FIG. 6A is an illustration of the general format of protocol messages used in the identity validation system of FIG. 1;

FIG. 6B is an illustration of the format of online and offline validation messages used in the identity validation system of FIG. 1;

FIG. 7 is an illustration of the format of system protocol messages used in the identity validation system of FIG. 1;

FIG. 8 is table illustrating system protocol messages;

FIG. 9 is a table illustrating user protocol messages; and

FIG. 10 is an illustration of a data format for a hash function H.

### DETAILED DESCRIPTION OF THE PREFERRED EMBODIMENT

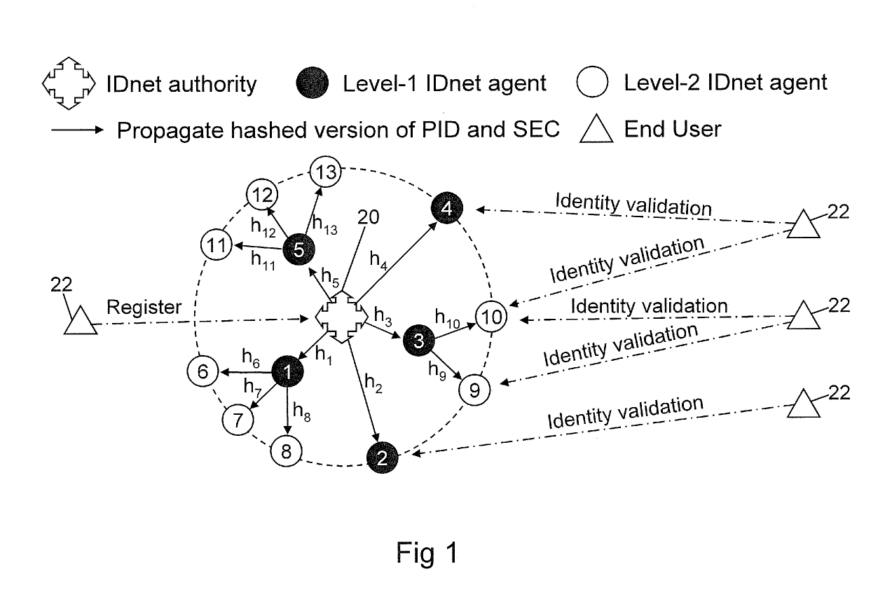

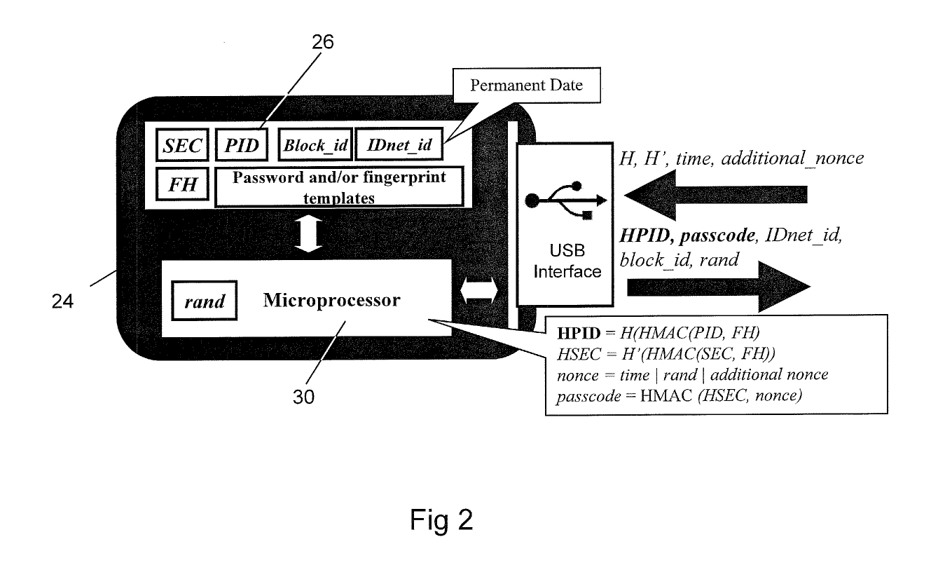

The identity validation network of the present invention, hereinafter referred to as IDnet, as shown in FIG. 1 includes an IDnet authority 20, a number of agents 1-13 and end users 22. Each user 22 registers a unique identity at an IDnet authority 20 that the user trusts most by providing the user's real identity (real name, national ID number, driver license number, or passport number, etc). This IDnet authority 20 at which the user has registered is called the user's home IDnet authority. After registration, the home IDnet authority 20 issues the user 22 an Internet passport 24, as shown in FIG. 2, and user software with which the user can access services that require identity validation. During the validation process, the user whose identity is being validated generates a temporary electronic identity, TID, and passcode which are sent to a selected agent 1-13 using the Internet passport 24 and user software for the agent to verify whether the TID is valid.

As noted above, each IDnet consists of two basic components: the ID-net authority 20 and the IDnet agents 22. The IDnet authority 20 is the authority that administers the IDnet. It maintains a central database that stores identity information for each registered user including information about the user's Internet passport and real identity. IDnet agents 1-13 are designed to provide high scalability for the identity validation service via large scale replication. Each IDnet agent replicates a different hashed copy of Internet passport data, excluding the real identity information, from the central database. A hash function is applied to the user's data to provide the hashed copy which is used instead of the original version of user data to ensure security. A hash function is a cryptographic function that when applied to the data results in a hashed copy from which the underlying data cannot be recovered so as to ensure security. Each agent stores a different hashed copy to effectively localize security threats wherein the IDnet authority 20 disseminates the different hashed copies to the different agents 1-13.

The home IDnet authority 20 issues each registered user a unique 160-bit or 20 byte permanent identity (PID) and a 160-bit or 20 byte secret code (SEC). This data is stored in a memory of an Internet passport 24 along with a database block identifier, block_id and a home IDnet authority identifier, IDnet_id. The Internet passport 24 is a small and cheap device that can be plugged into the user's computer via an USB port 28. The Internet passport is designed to support strong user authentication. It uses a built-in clock to generate a time-changing passcode used for identity validation based on the SEC. The reading of the passcode is unlocked via a user password and/or the user's biometric properties, e.g., thumbprint which are stored in the memory 26. The hardware of Internet passport is designed to be tamper-resistant such that it effectively deters any attempts to try to steal the SEC.

In a preferred embodiment, the Internet passport 24 is a smart card that communicates with a user's personal data device, e.g. personal computer, laptop, PDA, etc., via a conventional smart card reader, a biometric smart card reader, a USB dongle for a SIM-sized smart card, etc. Along with the memory 26, the smart card has a microprocessor 30 that generates a random number, rand. The microprocessor 30 is responsive to the receipt of hash functions H and H′ associated with a selected agent, as well as the current time and an additional nonce transmitted from the user's computer to generate a hashed version of the user's PID, i.e. HPID, and a passcode as discussed in detail below. The microprocessor 30 then sends HPID, passcode, IDnet-id, block-id and rand to the user's computer through the USB interface 28. In response to the receipt of this information from the microprocessor 30, the user software executed by the processor of the user's computer generates the user's temporary identity TID and transmits the TID and passcode to the selected agent for identity validation as discussed in detail below.

To make the identity validation service both scalable and secure, the IDnet authority propagates different hashed copies of each user's PID and SEC to each of the IDnet agents 1-13 . The propagation structure is a tree-like hierarchy as exemplified in FIG. 1. The root node of the tree is the IDnet authority 20. The rest of the nodes are IDnet agents 1-13. Each edge in the tree indicates a distinct propagation and each propagation uses a different hash function hᵢ. The IDnet authority first propagates hashed copies to level-1 IDnet agents 1-5, which in turn propagate hashed copies to level-2 IDnet agent 6-13, and so on. For example, the IDnet authority first propagates a hashed copy to agent 1 using hash function h₁. Then agent 1 propagates a hashed copy to agent 6 using hash function h₆. As a result, the hashed copy of PID and SEC being stored at agent 6 becomes h₆h₁ (PID) and h₆h₁ (SEC). Such a design effectively localizes security threats because each agent has a different hashed copy of the user's PID and SEC. A compromised agent can at most affect the subtree that roots at it and has no effect on the rest of the system. The identity validation service is provided at the IDnet's edge agents (i.e., leaf nodes of the tree) which are agents 6-13 as shown in FIG. 1. For each edge agent, the IDnet authority issues it a public key and a private key. Each agent announces to the public an agent entry which contains its public key and hash function sequence, e.g., h₆h₁ (•) for agent 6. The agent entry is signed by the IDnet authority 20.

In order to start an identity validation process, a user first chooses a suitable agent (denoted by i) by, for example, logging in to the agent i′s Internet site. In response, agent i transmits its hash functions Hᵢ and Hᵢ′ to the user's computer which, operating in accordance with user software, sends the agent i hash functions Hᵢ and Hᵢ′ to the user's Internet passport 24 along with the current time and an additional nonce. The Internet passport 24 then computes the hashed PID and SEC, denoted by HPIDᵢ and HSECᵢ, using the PID and SEC stored in the memory 26 and agent i′s hash function sequence using Equation (1) and (2).

HPIDi=Hᵢ(HMAC(PID, FH)) (eg. 1)

HSECi=Hᵢ(HMAC(SEC, FH)) (eg. 2)

Where HMAC is a keyed hash function using, for example, SHA-1 as its underlying hash algorithm and FFI is a first hash function assigned by the home IDnet authority and stored in memory 26. Then Internet passport then generates a passcode using Equation (3).

Passcode=(HMAC(HSEC, nonce)) (eg. 3)

where nonce=time|rand|additional nonce and “|” denotes the concatenation operation. After computing HPIDi, HSECᵢ and the passcode, the Internet passport 24 outputs HPIDi, the passcode, IDnet_id, block_id and rand to the user's computer.

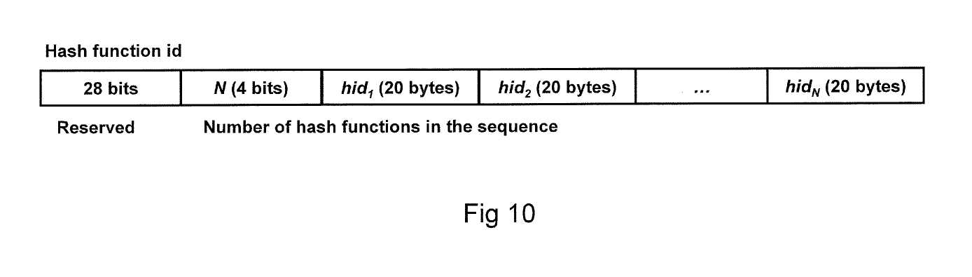

It is noted that a hash function sequence H denotes a unique composite hash function y=H(x). It is represented by its definition parameters in the data format shown in FIG. 10. The composite hash function y=H(x) is computed by iteratively applying each hash function Hₖ(x) in the sequence (k=1˜N). Each hₖ(x) is defined by the 16-byte hash function id, hidₖ wherein hₖ(x)=HMAC(x, hidₖ). The minimum number of hash functions in H is 1 and the maximum number of hash functions in H is 15. The following is an example for y=H(x). Suppose N=4, hid₁=23, hid₂=6, hid₃=9, hid₄=15, then y=H(x) is computed in the following way: x₁=HMAC(x, 23); x₂=HMAC(x₁, 6); x₃=HMAC(x₂, 9); y=HMAC(x₃, 15). For the same user at the same IDnet edge agent, the hash function sequences used to generate HPID and HSEC can be different. Therefore two hash function sequences are denoted by Hand H′ respectively.

The user software executed by the processor of the user's computer, receives a public key for agent i, PubKeyᵢ, along with Hᵢ and Hᵢ′ from agent i. Upon receiving HPIDᵢ, passcode, IDnet_id, block_id, and rand from the Internet passport, the user software computes nonce and the temporary identity TID according to equations (4) and (5).

nonce=time|rand|additional nonce (e.g. 4)

TID=RSA_Encrypt(IDnet_id|block_id|HPIDi|context|nonce, PubKeyᵢ) (e.g. 5)

It is noted that one choice of the public-key cryptography is the RSA cryptography and 1024-bit keys. In such a case, both the PubKey, and TID are 1024-bit (128 bytes) long. Also one choice for the encryption scheme is RSAES-OAEP (RSA Encryption Scheme-Optimal Asymmetric Encryption Padding). This is a public-key encryption scheme combining the RSA algorithm with the OAEP method. This encryption scheme is recommended by RFC-3447 for new applications in the interest of increased robustness. In addition to the RSA cryptography, ECC (elliptic curve cryptography) may be supported as well. ECC is a type of public-key cryptography based on the algebraic structure of elliptic curves over finite fields. It can provide more “security per bit” than other types of public-key cryptography. For example, a 163-bit key in ECC is as secure as a 1024-bit key in RSA; and a 256-bit key in ECC is as secure as a 3072-bit key in RSA. Another suitable encryption scheme is RSAES-PKCS1-v1_{—}5.

Next, the TID and passcode are sent to agent i, either directly from the end user or indirectly via relays. Upon receiving the TID and passcode, the agent software, when executed by a processor, first decodes TID using equation (6) to restore IDnet-id, block-id, HPIDᵢ, context, nonce.

(IDnet_id|block_id|HPIDi|context|nonce, PubKeyᵢ=RSA-Decrypt(TID, PriKeyᵢ) (e.g. 6)

The agent software then checks whether the time field decoded from nonce differs less than 30 seconds from its own clock. If not, it returns failure. If there is not a failure, the agent software queries its user database to fetch the user's HSECᵢ based on IDnet-id, block-id, and HPIDᵢ. If the corresponding user entry is not found, it returns failure. Otherwise, the agent software regenerates the passcode in the same way as the user does, i.e. using equation (3), and then checks whether it is the same as the passcode provided by the user. If not, the agent software returns failure. Otherwise, the identity of the user is validated and the agent software returns success.

For offline validation, the agent generates a 128-byte digital signature using the equation (7). The signature certifies the association between the TID and context. The agent then returns the signature to the user.

signature=RSA-Sign(TID|context, PriKeyᵢ) (eg. 7)

During the identity validation, the user's PID is not revealed so that others can only see the TID which includes hashed data wherein the underlying data to which the has function was applied is not recoverable. Further, equation (5) ensures that others are unable to distinguish whether two TIDs observed at two different times or places are associated with the same user. In this way, the solution retains each user's privacy.

To support user accountability, the home IDnet authority, and only the home IDnet authority, can resolve a user's real identity based on the TID and the agent used. To do this, the home IDnet authority i first recovers the user's hashed PID at the agent from the TID (using Equation (6)). Then it resolves the user's real identity by looking it up in a table that maps all users' original PIDs to their hashed PID at the agent.

A universal identity infrastructure can be formed by gradually merging IDnets. This universal infrastructure is referred to as an IDnet mesh. For example, several IDnets can merge together to form a small IDnet mesh. Later on, several small IDnet meshes can merge together to form a more universal IDnet mesh.

The first way of merging, referred to as high trust merging, is to simply merge the central databases of the two IDnet service providers. This is applicable for cases where the two providers have strong trusts with each other, e.g., one company has bought another company or two companies merge together thereby forming a new company under a single administration. The second way of merging, referred to as low trust merging, is for more general cases where the two IDnet service providers bear little trusts with each other but simply have a motivation to reuse each other's infrastructure. For such cases, they can merge by propagating to each other's central database a hashed version of their users' PIDs and SECs. It is noted that real identities and other private information are never propagated beyond a home IDnet. From the perspective of each IDnet authority, the other IDnet authority works essentially the same as one of its level-1 IDnet agents. This minimizes risks of the low trust merging. A system fault or a compromised agent that occurs in the other IDnet will not cause security threats on an IDnet's own infrastructure.

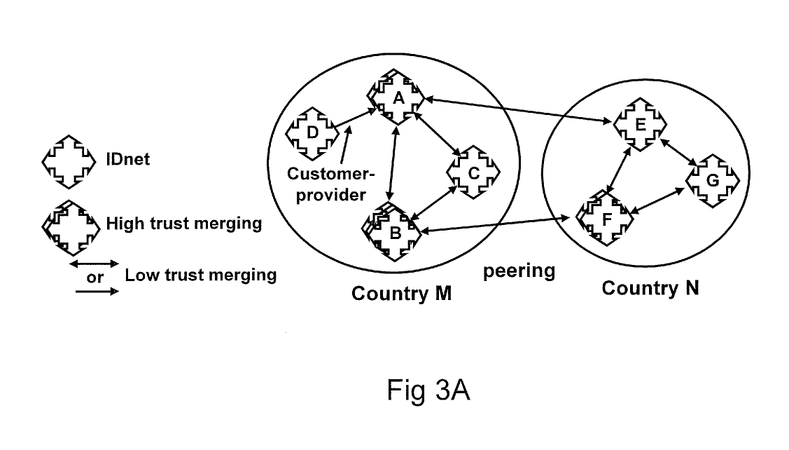

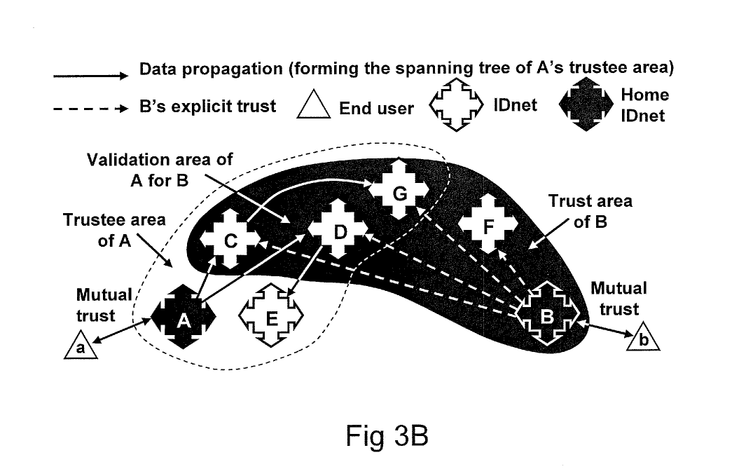

FIG. 3A exemplifies a big picture of merging in which seven IDnets belonging to two countries merge together and form a large ID-net mesh. IDnet A (or IDnet mesh A) results from high trust merging of two separate IDnets, thereby becoming equivalent to a single IDnet. IDnet B is similar, resulting from high trust merging of three IDnets. IDnet C merges with both IDnet A and B via low trust merging, thereby forming a peering relationship with them. There are also two pairs of IDnets across countries (A and E, B and F) forming a peering relationships via low trust merging. High trust merging may be rare between IDnets of two countries for security or other reasons. The merging between IDnet D and IDnet A is a special case of low trust merging in which D propagates its hashed user data to A while A does not do the same to D. This indicates a customer-provider relationship between them. D can be a special IDnet that only has IDnet authority but no agents, e.g., a university that maintains user accounts for all its students, staff, and faculty. D establishes a customer-provider service contract with A and propagates to A the hashed user data. In this way, D can use A′s infrastructure to provide wide-area identity validation service for its users.

In the above scenario, D might also ask A to further relay its hashed user data to B, C and E if A′s service agreements with B, C, and E allow this. In this way, D can also use B, C, and E′s infrastructures such that D′s identity validation service becomes more widely available even across the country. This type of relay is called identity forwarding. Identity forwarding can be an important approach to facilitate merging among IDnets. Although an IDnet may choose to directly merge with another IDnet instead of having a third IDnet provide identity forwarding for it, the identity forwarding approach is usually cheaper, e.g., it could be much more costly for C to establish a direct merging contract with the foreign IDnet E instead of having A forward for it.

Next an explanation is provided for the solution model for an underlying but fundamental question: How can we trust an IDnet that we previously do not know? This solution is the IDnet mesh's trust model. The initial trust between a user and the user's home IDnet is established in a mutual way. The user trusts this IDnet most, therefore the user selects it as the user's home IDnet. The home IDnet trusts the user, therefore it issues the user the Internet passport. This mutual initial trust serves as the starting point of the entire trust model which is depicted in FIG. 3B. First, we define the trustee area of an IDnet is defined. The trustee area of an IDnet is the area that consists of all IDnets that trust this IDnet. For example, the trustee area of IDnet A in FIG. 3B consists of IDnets C, D, E, and G. These IDnets trust A by allowing A to propagate its hashed user data to their databases. The propagation is performed either through direct propagation (via high trust or low trust merging, e.g., A→C and A→D) or through identity forwarding (e.g., A→C→G and A→D→E). The propagation structure can be represented by a spanning tree rooted at A to all other IDnets in the trustee area, i.e., there is a unique propagation route from A to each IDnet.

Second, the trust area of an IDnet is defined. The trust area of an IDnet is the area that consists of all IDnets that this IDnet trusts. It is quite different from the trustee area. The trust area is completely defined by each IDnet itself while the trustee area is decided by other IDnets' will. The IDnet explicitly expresses its trust by endorsing the digital certificates of other IDnets. In FIG. 3B, the IDnet B explicitly trusts IDnet C, D, F, and G, thereby defining its trust area. A trust area is defined on a per service basis and therefore it specifies not only who to trust but what to trust as well. For example, an IDnet can define very different trust areas for Web, Email, P2P, and VPN services.

Next, the validation area, which is associated with a pair of IDnets, is defined. Referring to FIG. 3B, the validation area of A for B is the overlapped area between A′s trustee area and B′s trust area. This area consists of all IDnets through which B′s users can validate identities of A′s users. B′s users admit the identity validation results because these IDnets are within B′s trust area. The identity validation for A′s users can be performed because these IDnets have imported the hashed version of A′s user data.

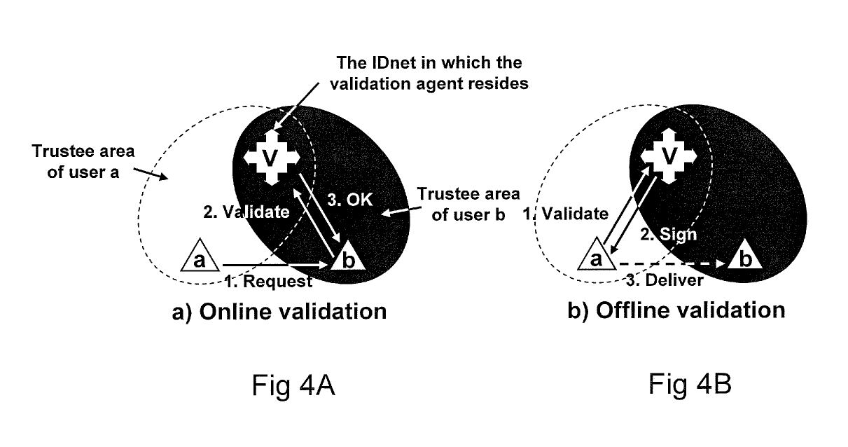

The IDnet mesh provides two basic identity validation services as shown in FIG. 4A and 4B for online validation and offline validation respectively. Before explaining the two services, the concept of a validation agent is introduced. Suppose that user A′s home IDnet is A and user B′s home IDnet is B. A validation agent of user a for user b is defined as any IDnet agent of any IDnet within the validation area of A for B. In online validation, user a sends her validation data, i.e. TID and passcode, along with the service request to user b. Then user b validates user a′s identity via a validation agent by relaying user a′s validation data. If the validation is successful, user b accepts user a′s service request, otherwise not. For example, user b could be a Web site and user a could be one of the web site's users. User b can use online validation to protect itself from malicious users.

In offline validation, there is no online communication between user a and user b. If user a wants to deliver a data object to user b, and user b wants to validate whether the object is sent from an accountable user then user a encodes the digital fingerprint, e.g., using SHA-1, of the object into the 160-bit service context (as shown in Equation (4)) to generate the TID. Then user a asks a validation agent to validate user a′s TID and passcode. If the validation is successful, the agent returns a digital signature that certifies the association between TID and the service context decrypted from TID. Next, user a delivers the data object together with the signature, TID, and the agent entry of the validation agent. user b can then verify the sender's accountability by checking the consistency among the signature, the object's fingerprint, and TID. For example, user b may only want to read Emails from accountable users to effectively counter SPAMs. Then an Email user a can use the offline validation to show the accountability.

It is noted that others have proposed network architectures that provide accountability as a first-order property or a network solution that decouples a host's identity from its topological location. Both of these solutions enable host accountability. However, host accountability is fundamentally different from the user accountability that the present invention provides. The key to solving the problems arising from lack of accountability as discussed in the background is to enable a regular approach to apply liability wherein liability is always applied to users, not hosts. Therefore, host accountability is insufficient. In addition, the systems proposed by others require fundamental changes to the current Internet infrastructure and protocols, and therefore are not incrementally deployable and readily available as the present invention.

User accountability is more or less conflicted with user privacy. The current Internet takes a relatively extreme position to favor user privacy by disabling user accountability. By contrast, the present invention stays neutral between the two sides. It can support both the extreme position of user privacy and the extreme position of user accountability. It is up to the applications and the sociopolitical domain of regulations to decide their positions to take. In addition, the present invention will accommodate a tussle between the two sides. Business competition among IDnets can ensure that an IDnet service provider must value both the privacy demands from the users and the accountability demands from the regulations, otherwise it will either lose the customers or be penalized by the regulations.

In a preferred embodiment, each IDnet authority or agent maintains a user database which stores both user data of its own IDnet and user data propagated from other IDnets. Data of each user is represented by a user entry. Each user entry is a 3-tuple {HPID, HSEC, block_id}. HPID and HSEC are the hashed version of a user's PID and SEC at this IDnet authority or agent. At a user's home IDnet authority, these two fields are the original PID and SEC. Block_id is an identifier of user block. User data of each IDnet is divided into large user blocks. Each block may contain up to 100,000 user entries. The block_id is 2-byte long. This means that each IDnet can have up to 64K blocks, which correspond to up to 6.5 billion users. The user database is implemented as a set of tables with the same structure in MySQL database. Each user entry corresponds to a row in a table. Each table stores up to 16 user blocks of an IDnet. Therefore, each table can hold up to 1.6 million user entries. The name of each table is a 48-character string that encodes both ID-net identifier and block identifier for the user data in the table. The first 5 characters are the prefix “IDnet.” The remaining 43 characters are the hexadecimal representation of the 20-byte IDnet identifier and the higher 12-bits of the block identifier. Each IDnet identifier is a self-certifying flat name generated using SHA-1.

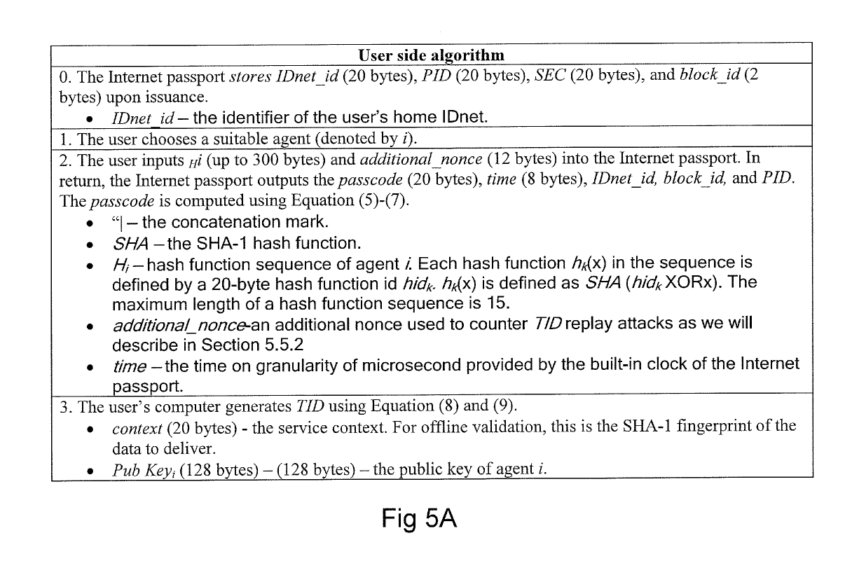

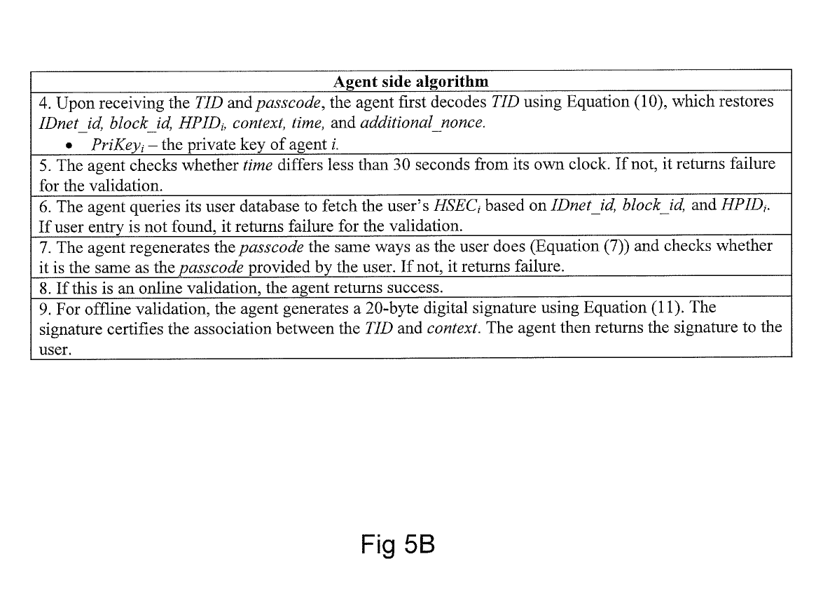

FIGS. 5(a) and 5(b) describe in details the algorithm both at the end user and at the edge agent. The software code may be written in C++. The Crypto++ library for cryptographic functions such as SHA-1 and RSA may be used. For example one can use RSAES-OAEP for the RSA encryption scheme and RSASSA-PSS for the RSA signature scheme, both of which are recommended by RFC-3447 for new applications in the interest of increased robustness.

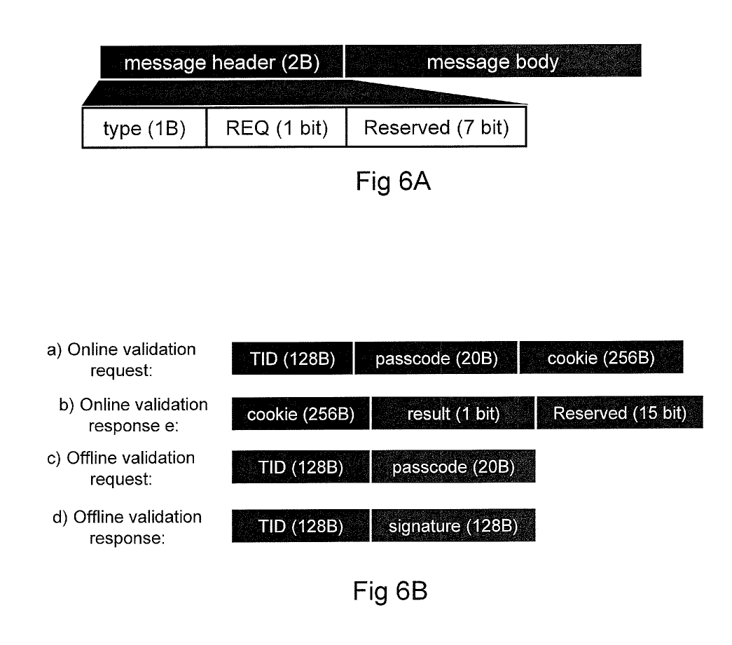

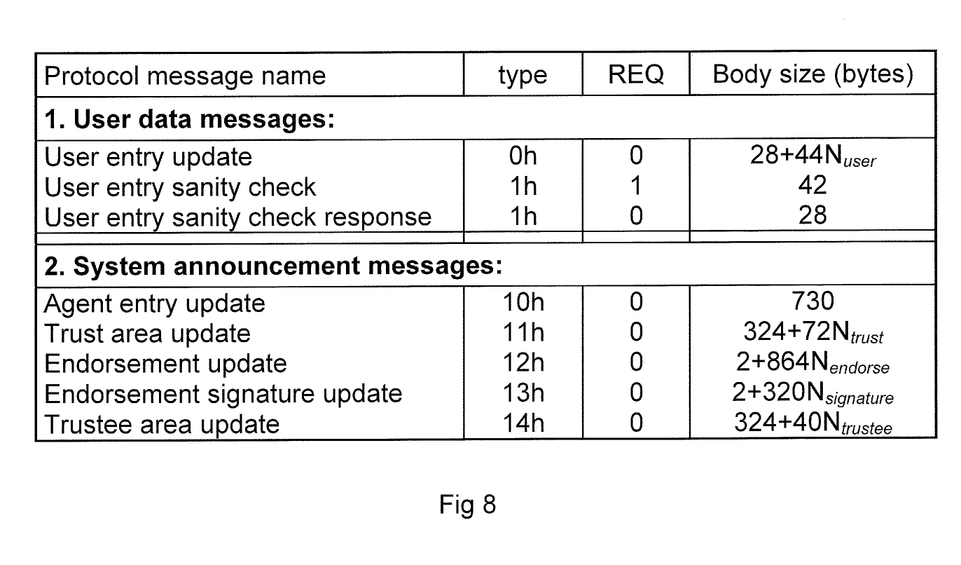

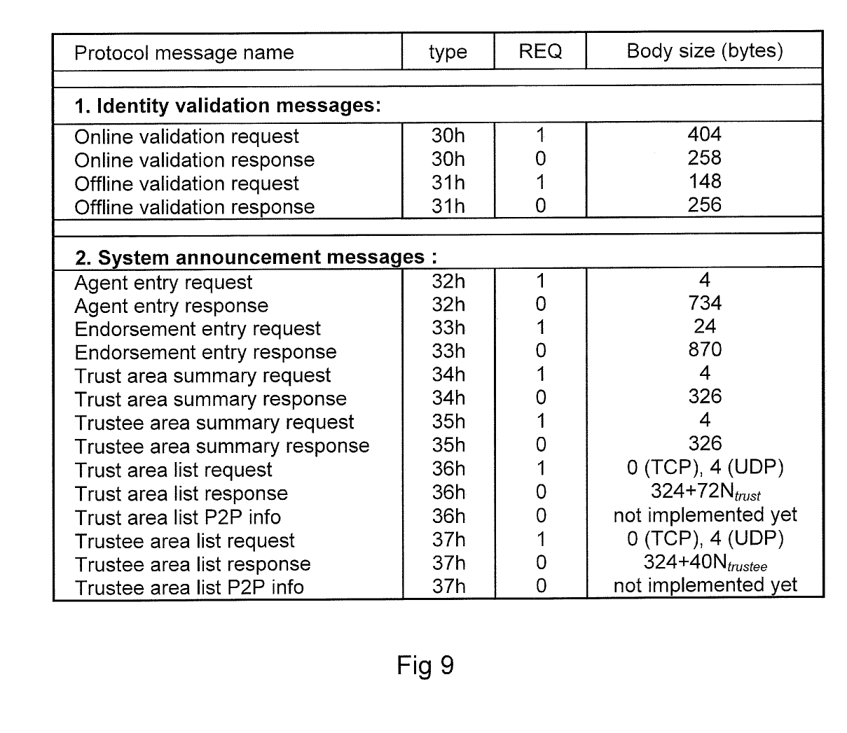

The IDnet system has two types of protocols, the IDnet system protocol and the IDnet user protocol. The IDnet system protocol works among IDnet authority and agents of the same IDnet or between IDnet authorities of two different IDnets. The IDnet user protocol works between IDnet edge agents and users. Both types of protocols share the same general message format as shown in FIG. 6A. All messages are implemented upon TCP or UDP. Each message consists of a 2-byte message header and a variable length message body. The message header includes two fields: (i) type code, which specifies the message type, and (ii) REQ bit, which indicates whether this message is a request. FIGS. 8 and 9 summarize all IDnet system protocol messages and user protocol messages.

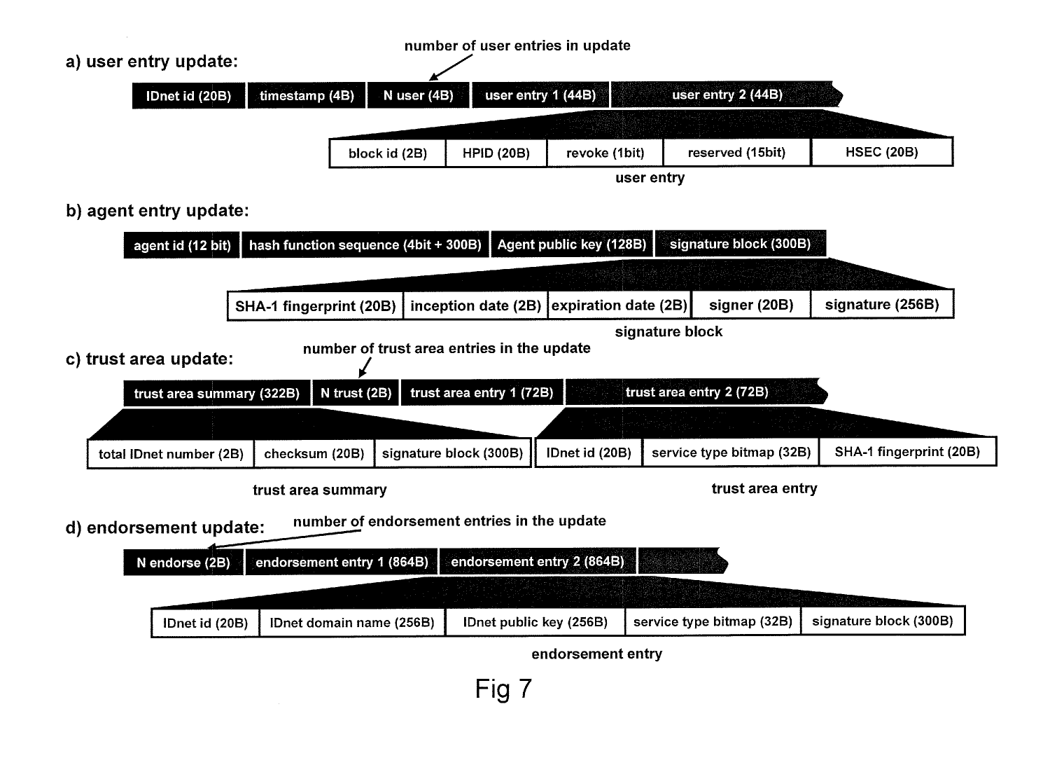

There are eight types of IDnet system protocol messages as listed in FIG. 8, five of which are illustrated in details in FIG. 7. They are divided into two categories, user data messages and system announcement messages. The user data messages are used to propagate hashed version of user data from an IDnet authority to all its agents and to other IDnet authorities. The system announcement messages are used to propagate system announcements, e.g., information about agents, trust area and trustee area, from an IDnet authority to all its agents. Among the eight types of messages, only user entry sanity check and user entry sanity check response use UDP. All the rest six use TCP.

User entry update is the main user data message. It consists of a list of user entries that need to be updated. The field Nᵤₛₑᵣ specifies the number of user entries carried in this message. The field IDnet_id specifies the home IDnet for the carried user data. The field HPID and HSEC in each user entry is the hashed version of a user's PID and SEC. A user entry update for a specific IDnet initiates from its IDnet authority and later propagates to all IDnet agents within its trustee area. The propagation paths are: (i) from an IDnet authority to other IDnet authorities, (ii) from an IDnet authority to all its level-1 agents, and (iii) from a level-1 agent to all its level-2 agents, etc. At each propagation hop, an additional hash function is applied to the HPID and HSEC fields in each user entry. The user entry updates initiated by an IDnet are preferably paced at one-hour intervals. Each user entry update can be ensured to be propagated to all IDnet agents in the trustee area within the next hour. Such design ensures that any user data changes made at a home IDnet authority can be updated to the whole trustee area within two hours. User entry sanity check and user entry sanity check response are designed for maintenance purpose. They help to verify the consistency among user databases of different IDnet authorities and agents. Agent entry update is designed to announce agent information. Each agent entry update contains one agent entry. The agent entry consists of the identifier, hash function sequence, and public key of an agent. In addition, it includes a signature block which certifies the entry. The signature block includes: (i) an SHA-1 fingerprint for all data in the agent entry except the signature block itself, (ii) the inception date and expiration date of the signature, (iii) the signer, which is the IDnet identifier, and (iv) a 2048-bit RSA signature by the IDnet authority. The signature block is updated every day and expires after two days.

An IDnet authority may update agent entries for all its edge agents every day. If no changes happened to information of an agent, which is the majority case, only the signature block needs to be updated. The IDnet authority then propagates each agent entry update to the corresponding edge agent in this IDnet.

Trust area update is designed to announce the trust area definition for an IDnet. An IDnet authority propagates a trust area update to all its agents every day. The update includes a trust area summary and a list of trust area entries. The number of trust area entries is specified by Nₜᵣᵤₛₜ Each trust area entry corresponds to an IDnet in the trust area. It consists of the IDnet identifier and a 256-bit service type bitmap. The service type bitmap defines types of services that the specified IDnet is trusted for. If all bits of this bitmap are set to zero, the specified IDnet will be revoked from the trust area. The trust area entry also includes an SHA-1 fingerprint for the rest two fields.

The trust area summary is a short digest for trust area definition. Nₜᵣᵤₛₜ_{_{—}}_{total is} the total number of IDnets in the trust area. checksum is the sum of SHA-1 fingerprints of all trust area entries. It is noted that this is not necessarily the sum of SHA-1 fingerprints for trust area entries carried in the message. That is because a trust area update is usually incremental which only includes those IDnets whose information have been changed. The trust area summary also contains a signature block the same as the agent entry does. The signature block is updated every day and expires after two days.

Endorsement entry update is designed to announce and certify information about each IDnet in the trust area. It consists of a list of endorsement entries. The number of endorsement entries is specified by Nendorse Each endorsement entry includes the identifier, domain name, and public key of an IDnet. It also includes a service type bitmap the same as in the trust area entry. In addition, it contains a signature block that certifies the rest four fields. The signature block is updated every day and expires after two days.

Endorsement signature update is a compact version of endorsement entry update. When information about an IDnet is not changed, we only need to update the signature block in its endorsement entry. Therefore, we use the endorsement signature update to accomplish this. Each update consists of a list of endorsement signature entries, which only include the identifier and signature block for each IDnet.

In the general case, the IDnet authority propagates both an endorsement entry update and an endorsement signature update to all its agents every day. The endorsement entry update includes entries for IDnets whose information has been changed, while the endorsement signature update includes entries for the rest IDnets.

Trustee area update is designed to announce the trustee area definition for an IDnet. An IDnet authority propagates a trustee area update to all its agents every day. The format of trustee area update is very similar to that of the trust area update as shown in FIG. 7.

The IDnet user protocol messages are divided into two categories—identity validation messages and system announcement messages as shown in FIG. 9. The identity validation messages define the request and response format for online and offline validation services. Their formats are illustrated in FIG. 6B. The system announcement messages enable end users to fetch and refresh system announcements from IDnet edge agents. All IDnet user protocol messages use UDP except for trust area list request/response and trustee area list request/response.

For online validation, a public service provider, e.g., a Web site, relays its customers' identity validation data to an IDnet edge agent in form of the online validation request. Each request includes (i) the TID and passcode provided by a customer, and (ii) a 256-byte cookie which can be used by the service provider to encode service session identifier and states associated with the session. With the cookie, the service provider do not have to maintain any states for a service session until the validation completes. When the IDnet edge agent finishes the validation, it returns the result to the service provider in form of the online validation response. The response includes (i) the 256-byte cookie copied from the request, which helps the service provider to restore the customer session, and (ii) a result bit that indicates whether the customer passes the validation or not. For offline validation, a user first sends an offline validation request to an IDnet edge agent. The request includes the TID and passcode. After the validation, the agent returns an offline validation response to the user. The response consists of the TID and the signature that certifies the association between the TID and the service context field decrypted from the TID. The signature is set to zero if the validation fails.

System announcement messages include the following. An agent entry request/response allows a user to fetch and update the agent entry for the edge agent that the request is sent to. An endorsement entry request/response allows a user to fetch and update the endorsement entry for a specified IDnet in the trust area. A trust area summary request/response allows a user to fetch and update the trust area summary. A trustee area summary request/response allows for a user to fetch and update the trustee area summary. A trust area list request/response allows a user to fetch the whole list of trust area entries that correspond to all IDnets in the trust area. The list also contains the trust area summary It is noted that the above pairs of messages may be implemented using TCP. In addition, since the data carried in the response is signed by the IDnet authority, a user does not have to download them directly from the IDnet agent. Instead, a P2P application can be used for delivery. Therefore a UDP version of trust area list request can also be used. An agent responds to this version of request with a trust area list P2P info message which carries the P2P information for the data to deliver. Trustee area list request/response/P2P info are designed in a similar way as trust area list request/response/P2P info. But they serve for trustee area information instead of the trust area information.

Many modifications and variations of the present invention are possible in light of the above teachings Thus, it is to be understood that, within the scope of the appended claims, the invention may be practiced otherwise then as described herein above.

What is claimed is:

1. In an identity validation system for a user that has registered the user's real identity with a home identity authority that has issued a unique permanent identity and secret code to the user and that has disseminated a different hashed version of the user's permanent identity and secret code to each of a plurality of different agents, each hashed version being generated using different agent hash functions associated with each of the different agents, a user passport device comprising:
a memory for storing user data including the user's permanent identity and secret code and a user password and/or biometric;
an interface to a personal data device capable of communications via the internet; and
a processor operable to generate hashed versions of the stored permanent identity and secret code using at least one agent hash function associated with the agent selected to perform the identity validation and said processor being operable to generate a time varying passcode using the hashed version of the secret code.

2. The identity validation system as recited in claim 1 wherein the user passport device includes a smart card and a smart card reader.

3. The identity validation system as recited in claim 2 wherein the smart card reader is a biometric smart card reader.

4. The identity validation system as recited in claim 1 wherein the interface is a USB interface.

5. The identity validation system as recited in claim 1 wherein the memory of the user passport device further stores a database block identifier and an identity network identifier that are transferred through the interface with the hashed version of the permanent identity and the passcode.

6. The identity validation system as recited in claim 1 wherein the time varying value passcode is generated using a hashed version of the secret code, a current time, a random number and a keyed hash function.

7. The identity validation system as recited in claim 1 wherein the hash function used to generate the hashed version of the permanent identity is a different function from the hash function used to generate the secret code.

8. In an identity validation system for a user that has registered the user's real identity with a home identity authority that has issued a unique permanent identity and secret code to the user and that has disseminated a different hashed version of the user's permanent identity and secret code to each of a plurality of different agents, each hashed version being generated using different agent hash functions associated with each of the different agents, a user system comprising:
a user passport device comprising:
a memory for storing permanent user data including the user's permanent identity and secret code and a user password and/or biometric;
an interface to a personal data device capable of communications via the internet; and
a processor operable to generate hashed versions of the stored permanent identity and secret code using at least one agent hash function associated with the agent selected to perform the identity validation and said processor being operable to generate a time varying passcode using the hashed version of the secret code; and
user software executable on the personal data device and operable to generate a temporary identity for the user that includes an encrypted version of the user's hashed version of the permanent identity and a public key, the temporary identity and the passcode being transmitted to the agent selected to perform the identity validation.

9. In the identity validation system as recited in claim 8 wherein the memory of the user passport device further stores a database block identifier and an identity network identifier that are transferred through the interface with the hashed version of the permanent identity and the passcode to the personal data device and the user software executable on the personal data device is operable to generate a temporary identity for the user that includes an encrypted version of the database block identifier and identity network identifier along with the user's hashed version of the permanent identity and the public key.

10. The identity validation system as recited in claim 8 wherein the hash function used to generate the hashed version of the permanent identity is a different function from the hash function used to generate the secret code.

11. The identity validation system as recited in claim 8 wherein the user passport device includes a smart card and a smart card reader.

12. The identity validation system as recited in claim 8 wherein the time varying value passcode is generated using a hashed version of the secret code, a current time, a random number and a keyed hash function.

13. The identity validation system as recited in claim 8 wherein the user software uses an RSA encryption scheme to generate the temporary identity.

14. In the identity validation system as recited in claim 13 wherein the encryption scheme is RSAES-OAEP or RSAES-PKCS1-v_{—}5.

15. In an identity validation system for a user that has registered the user's real identity with a home identity authority that has issued a unique permanent identity and secret code to the user and that has disseminated a different hashed version of the user's permanent identity and secret code to each of a plurality of different agents, each hashed version being generated using different agent hash functions associated with each of the different agents, agent software executable by a processor to perform the operations comprising:
receiving from an identity authority a hashed version of a user's permanent identity and secret code generated using at least one agent hash function associated with the agent;
storing in a memory the hashed versions of the user's permanent identity and secret code;
receiving a temporary identity and a passcode transferred via the internet to the agent from a user, the temporary identity including an encrypted version of the user's hashed version of the permanent identity and a public key and the passcode including a hashed version of the secret code;
decoding the received temporary identity to recover the user's hashed version of the permanent identity;
retrieving from the memory the hashed secret code using information recovered from the decoded temporary identity;
generating a passcode using the retrieved hashed secret code; and
comparing the passcode generated from the retrieved hashed secret code to the passcode received from the user to validate the identity of the user.

16. The identity validation system as recited in claim 15 wherein the received temporary identity further includes an encrypted time field and the agent software when executed is operable to decode the temporary identity to recover the time field, and to determine whether the recovered time field is within a predetermined amount of time from a current time.

17. An identity validation system for a user that has registered the user's real identity with a home identity authority that has issued a unique permanent identity and secret code to the user comprising:
home authority software that is executable by a processor to generate a plurality of different hashed versions of the user's permanent identity and secret code using a plurality of different hash functions, each hash function associated with a different agent, the different hashed versions of the user's permanent identity and secret code being transmitted to the respective different agents;
a user passport device including a memory for storing the user's permanent identity and secret code and a processor operable to generate hashed versions of the stored permanent identity and secret code using an agent hash function associated with an agent selected to perform the identity validation and said processor being operable to generate a time varying passcode using the hashed version of the secret code;
user software executable by a processor to generate a temporary identity for the user that includes an encrypted version of the user's hashed version of the permanent identity and a public key for transmission with the passcode to the agent selected to perform the identity validation; and
agent software executable by a processor to receive from the home authority a hashed version of a user's permanent identity and secret code for storage in a memory; receive a temporary identity and a passcode from a user; and validate the user's identity based upon the received temporary identity and passcode and the stored hashed version of the user's permanent identity and/or secret code.

18. The identity validation system as recited in claim 17 wherein the user passport device includes a smart card and a smart card reader.

19. The identity validation system as recited in claim 17 wherein the memory of the user passport device further stores a database block identifier and an identity network identifier that are transferred through the interface with the hashed version of the permanent identity and the passcode.

20. The identity validation system as recited in claim 17 wherein the time varying value passcode is generated using a hashed version of the secret code, a current time, a random number and a keyed hash function.

21. The identity validation system as recited in claim 17 wherein the hash function used to generate the hashed version of the permanent identity is a different function from the hash function used to generate the secret code.

22. In the identity validation system as recited in claim 17 wherein the memory of the user passport device further stores a database block identifier and an identity network identifier that are transferred through the interface with the hashed version of the permanent identity and the passcode to the personal data device and the user software executable on the personal data device is operable to generate a temporary identity for the user that includes an encrypted version of the database block identifier and identity network identifier along with the user's hashed version of the permanent identity and the public key.

23. The identity validation system of claim 17 wherein the agent software when executed by a processor is operable to decode a received temporary identity to recover the user's hashed version of the permanent identity; to retrieve from memory a hashed version of the secret code using information recovered from the decoded temporary identity; to generate a passcode using the retrieved hashed secret code; and to compare the generated passcode to the received passcode to validate the identity of the user.

24. The identity validation system as recited in claim 17 wherein the user software uses an RSA encryption scheme to generate the temporary identity.

25. In the identity validation system as recited in claim 24 wherein the encryption scheme is RSAES-OAEP or RSAES-PKCS1-v1_{—}5.
